(19) United States
(12) Patent Application Publication
(10) Pub. No.: US 2002/0065811 A1
(43) Pub. Date: May 30, 2002

(54) Ensured access to static objects inside a dynamic token memory

(75) Inventors: Ernst-Michael Hamann, Boeblingen (DE); Robert Sulzmann, Holzgerlingen (DE)

Correspondence Address: WILLIAM KINNAMAN, JR., IBM Corporation, Intellectual Property, Law Department, 2455 South Road, M/S P386, Poughkeepsie, NY, 12601, US

(73) Assignee: INTERNATIONAL BUSINESS MACHINES CORPORATION, ARMONK, NY (US)

(21) Appl. No.: 09/931,613

(22) Filed: Aug. 16, 2001

(30) Foreign Application Priority Data
Aug. 18, 2000 (EP) 00117786.4

(51) Int. Cl. G06F 7/00

(52) U.S. Cl. 707/2

(57) ABSTRACT

The present invention relates to electronic data carrier file systems, and in particular to file system management for small handheld data carriers, particularly for smart cards, i.e., chipcards having an own processor means. According to the present invention, static data objects are managed in a dynamic file system. A kind of embedment takes place in which one or more static objects are embedded in the dynamic file system within a file. The static objects are excluded from management actions performed on the dynamic file system. The static, embedded objects may have a fixed memory address inside the dynamic file system and cannot be moved to a different location by the dynamic file management functions. The static data objects can be accessed by easy command sequences without any complex file management functions, for example by boot routines in order to check personal security-relevant data.

### BACKGROUND OF THE INVENTION

1. Field of the Invention

The present invention relates to electronic data carrier file systems. In particular, the present invention relates to file systems for small hand held data carriers, particularly for smart cards, i.e., chipcards having their own processor means.

2. Description of the Related Art

A new area of technology with increasing importance is represented by the increasing use and acceptance of chipcards and their applications for many different purposes. Such applications need the ability to store data on media so that they can be retrieved at a later point in time. Under normal circumstances they use the file interface provided by the operating system on which the application is running. The operating system makes use of file systems to store the data on hardware and to keep the data consistent.

Chipcards have only limited computing resources. Even up-to-date chipcard design is limited in flexibility or user convenience by the constraint to implement either a static or a dynamic file system. Both of them have their particular disadvantages.

As to static file systems static data objects can be accessed with simple access routines provided by the card itself under the constraint that the chipcard applications have to store the objects in a known structure in a specific data file with a known ID. But the storing of objects in fixed structures in a defined file on a chipcard is not flexible enough for most applications, and it consumes too much space on the space-limited smart card. Further, the static files are not flexible enough in space management and are not easily created after issue of the card because the card issuer may restrict file manipulation with access rights for security reasons.

Moreover, in multi-application chipcards the memory location of data which may be needed by all applications, like personal identification numbers (PINs) or other security-relevant data, must be known to all applications, which is difficult to manage.

Thus, for a flexible management of data objects on a card, basically, a dynamic file system is needed, but this does not guarantee fixed addresses for a particular, specific object which is desirable from a different point of view:

When objects on the smart card are managed dynamically in a dynamic file system an area, i.e., a file on a smart card can be defined as a dynamic storage. But the management of the data objects is performed through access routines running outside of the smart card in the PC, because the chipcard's resources lack performance to do that by themselves efficiently.

Most of the chipcard applications accessing the dynamic objects use the host PC's dynamic access routines to increase flexibility of chipcard file system management.

For some applications or devices, however, it is not possible to use these access routines, because of limited space available for their program code. Examples are boot routines running before the PC's operating system is started, or handheld devices with strongly limited resources, like for example a pocket reader for chipcards.

Thus, it is an objective of the present invention to combine the advantages of both the dynamic and the static file systems on a chipcard.

### SUMMARY OF THE INVENTION

These objects of the invention are achieved by the features stated in the accompanying independent claims. Further advantageous arrangements and embodiments of the invention are set forth in the respective subclaims.

According to the present invention, static data objects are managed in a dynamic file system. A kind of embedment takes place in which one or more static objects are embedded in the dynamic file system within a file. The static objects are excluded from management actions performed on the dynamic file system.

The static embedded objects may have a fixed memory address inside the dynamic file system and cannot be moved to a different location by the dynamic file management functions, e.g. for free space management, defragmentation purposes.

By this approach the static data objects can be accessed by easy command sequences without any complex file management functions as was mentioned above, for example by boot routines.

On the other hand, the static data objects can also be accessed by the file management functions of the dynamic file system. No additional static files are necessary on the card to hold the static data objects.

Advantageously, security-relevant data can be stored in the static objects the access of which is then ensured by primitive access routines just indicating a fixed address and a maximum size for the object.

This feature can also be applied advantageously for multi-application chipcards in order to manage just one single set of user identification or authentication data instead of a separate set for each application. This increases the user convenience because a user needs not remember a lot of PINs, passwords, user names, etc.

Further, the term ‘embedding’ does not necessarily mean that the inner part is surrounded from both sides by the ‘bed’. Rather, it also includes semi-embedment, in which the static object lies at one end of the overall storage area.

Finally, the approach of the present invention can also be inverted: The combination of static and dynamic file systems of the present invention can also be achieved by embedding a dynamic file system in a static file system.

### BRIEF DESCRIPTION OF THE DRAWINGS

The present invention is illustrated by way of example only and is not limited by the shape of the figures of the accompanying drawings in which:

FIG. 1 is a schematic representation illustrating the placement of two static objects embedded in a dynamic file system, and

FIG. 2 is a schematic representation illustrating the placement of one static object embedded in a dynamic file system which changes the dynamic objects over time.

### DESCRIPTION OF THE PREFERRED EMBODIMENT

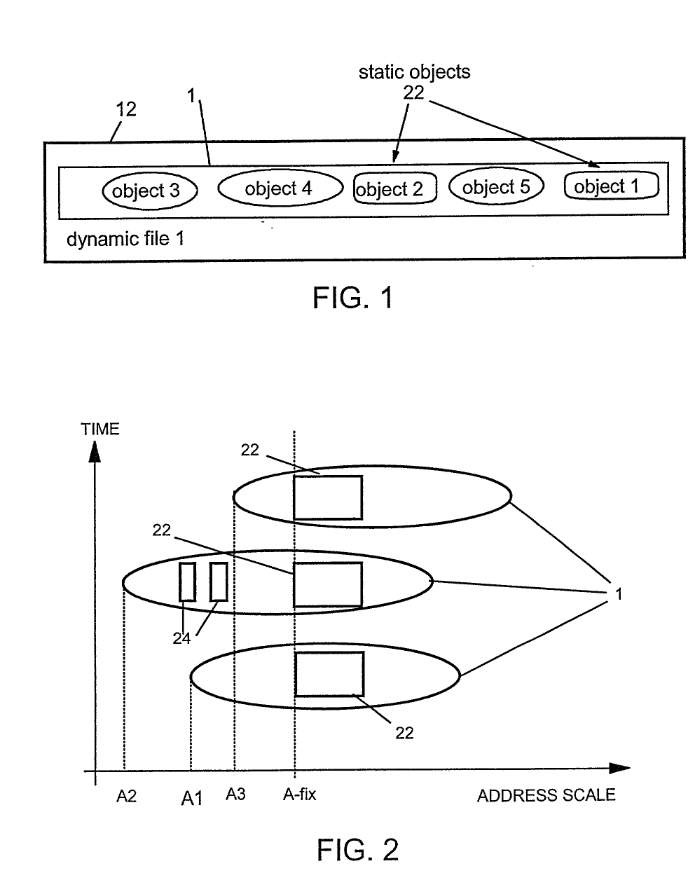

With general reference to the figures and with special reference now to FIG. 1 one dynamic file 1 which forms part of a file system 12 having a plurality of files and a prior art directory structure has several data objects 1, . . . , 5. Objects 1, 2 are static objects, whereas objects 3, 4, 5 are dynamic objects. As can be seen from the drawing the static objects 1, 2 are embedded within the file 1 of the file system 12. The dynamic objects 3, 4, 5 are shown to be managed on the same hierarchy level as is done with the static objects 1, 2.

FIG. 2 shows three different situations occurring in the course of time, time increasing in the y-direction to the top. The x-direction indicates the address scale, a linear scale which orders the storage locations of the total storage area of the file 1 from FIG. 1.

By different actions exerted on the dynamic file system this is changed over time, which is illustrated by the moving file 1 covering different ranges of the address space. In the bottom situation the dynamic file starts with an address A1, in the middle situation with A2, and in the top situation with A3. In the middle situation, additionally two memory leaks 24 are depicted in order to show that the system should be defragmented, which was done as can be seen in the top situation. As can be seen from the drawing, for the start addresses the following relationship holds: A2<A1<A3. The size of the dynamic file is illustrated to increase slightly, as well. As is revealed by the drawing, however, the static object 22 is not changed at all. It keeps its start address depicted as A-fix, and keeps its size, even if the content of the object might have been changed in the course of time.

So, assuming security-relevant data to be stored in the static object 22 of the file system of a chipcard, the data can be easily read for example by a pocket reader for verifying the data, before the host operating system is booted. It is sufficient to simply know the start address and size of the object. The same yields for a plurality of objects not shown in the drawing to increase its clarity. Thus, in the pre-boot phase the data can already be read. If they are not verified, the system need not boot at all. This saves time for the card user. The creation of static objects is described now in more detail next below:

Basically, static objects may be created in two different advantageous ways:

The first way is to create the static object during initialization or personalization of the smart card. The directory information stored on the card for the dynamic access routines must be initialized. Such initialization means reserving a specified address inside the dynamic file with a specified length and marking it as static so that the above-mentioned dynamic access routines will not move any static object. The address inside the dynamic file can then be easily accessed and used by primitive devices or applications.

The second way is to create the static object after issuing the card with the dynamic file access routines.

A so-called CreateStaticObject function can be used to create a static object by specifying a particular size only. This function scans the available free storage area and returns an adequate start address location that can be used to access the object by primitive devices and applications.

Or, alternatively, a so-called CreateStaticObjectByAddress function can be used to create a static object by specifying both an address and a size. This function tries to create the static object at the specific address. If the so defined storage area is fully or partly occupied by one or more other dynamic objects, they are moved to another location inside the dynamic space.

These routines also manage the directory information used by the dynamic file access routines.

Next, a straightforward description exemplifing of the above-mentioned two functions.

Creating a static object with a so-called CreateStaticObject:

1. Check the specified object size to see if it fits into the file system.

2. Get the directory information for the dynamic file system.

3. Loop through directory entries and find a sequence of consecutive unused memory bytes inside the file system, where the specified object size will fit. A best-fit algorithm may be used to find the best matching sequence.

4. Create an directory entry for the new object and set a flag to mark the entry as a ‘Static Object’. This directory entry contains the address and the size of the new object.

5. Write the directory entry to the file system inside the device (e.g. smart card)

Creating a static object with so-called CreateStaticObjectByAddress:

1. Check the specified object size to see if it fits into the file system.

2. Get the directory information for the dynamic file system.

3. Loop through directory entries and check if a sequence of consecutive unused memory bytes is available at the specified address with the specified size inside the file system.

4. If another non-static object is occupying some bytes of the demanded file system space, the file system tries to move the object by copying the data to another location and updating the corresponding directory entry.

5. If another static object is occupying the demanded file system space or a move of a non-static object is not possible, an error will be returned.

6. Create a directory entry for the new object and set a flag to mark the entry as a ‘Static Object’. This directory entry contains the address and the size of the new object.

7. Write the directory entry to the file system inside the device (e.g. smart card)

Further, the static objects can be deleted by the above-mentioned dynamic file access routines, including updating the directory information for the dynamic storage on the card.

It should be noted that the static objects in the combined file management system of the present invention can be accessed by the dynamic access functions in the normal way like other dynamic objects. Updates can be made with the limitation that the size of the object cannot be changed.

In addition the static objects can be accessed by primitive devices and applications using simple commands just indicating the start address and the offset. For example, a small handheld device reads information from the card by power-on of the card, selecting the dynamic file, and reading the data with a known size at a known address inside this file with a primitive read command.

The same mechanism can be used for updating the static data object by using the known address and the known size. The only restriction is that the size of a static object cannot be increased.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

The present invention can be realized in hardware, software, or a combination of hardware and software. The combined file system of the present invention is not restricted to chipcard memory management although this is a primary application field. Any kind of computer system or other apparatus adapted for carrying out the methods described herein is basically suited. A typical combination of hardware and software could be a any computing device with a computer program that, when being loaded and executed, controls the device such that it carries out the methods described herein.

The present invention can also be embedded in a computer program product, which comprises all the features enabling the implementation of the methods described herein, and which when loaded in a computer system is able to carry out these methods.

Computer program means or computer program in the present context means any expression, in any language, code or notation, of a set of instructions intended to cause a system having an information processing capability to perform a particular function, either directly or after either or both of the following: a) conversion to another language, code or notation; b) reproduction in a different material form.

What is claimed is:

1. A method for managing a dynamic file system, comprising the step of:
embedding one or more static data objects in the dynamic file system which are excluded from actions performed dynamically on the file system.

2. The method of claim 1 comprising the step of:
defining an embedded static object by a memory address and a fixed size.

3. The method of claim 1 comprising the steps of:
creating an embedded static data object by specifying a predetermined storage size;
scanning memory for an available storage area large enough in size for receiving the static data object; and
allocating the storage area for the static object.

4. The method of claim 1 comprising the steps of:
creating an embedded static data object by specifying a storage area having a predetermined memory address and a predetermined storage size;
allocating the storage area if it is not being used; and
if the area is already in use, moving data using the area to a different memory location and allocating the area thereafter:

5. The method of claim 1 used for managing a file system on a chipcard.

6. The method of claim 5 comprising the step of accessing a static object in a pre-boot phase of a host system connected to the chipcard.

7. The method of claim 6 comprising the step of storing security-relevant data in a static object.

8. A chipcard comprising a dynamic file system managed by the method of claim 1.

9. A computer operating system program for execution in a data processing system comprising computer program code portions for performing respective steps of the method of claim 1 when the code portions are executed on the data processing system.

10. A computer program product stored on a computer usable medium comprising computer readable program means for causing a computer to perform the method of claim 1 when the program product is executed on the computer.
